(19) United States
(12) Patent Application Publication
(10) Pub. No.: US 2008/0207799 A1
(43) Pub. Date: Aug. 28, 2008

(54) Electrically conductive strands, fabrics produced therefrom and use thereof

(76) Inventors: Kurt-Gunter Berndt, Graben (DE); Rex Delker, Wehringen (DE)

Correspondence Address: FERRELLS, PLLC, P. O. BOX 312, CLIFTON, VA, 20124-1706, US

(21) Appl. No.: 12/070,782

(22) Filed: Feb. 21, 2008

(30) Foreign Application Priority Data
Feb. 24, 2007 (DE) DE 102996998118.6

(51) Int. Cl. C08K 7/02

(52) U.S. Cl. 523/222

(57) ABSTRACT

Described are melt-spun strands having a modulus of elasticity of less than 6 GPa and an elastic extension of greater than 1.5%, comprising a) a thermoplastic polymer, b) a thermoplastic elastomeric block copolymer, and c) carbon black and/or graphite particles in the form of aggregates aligned along the longitudinal axis of the strand which form electrically conductive paths along the longitudinal axis of the strand.

The strands exhibit very high electrical conductivity and are useful for forming screens, wires, sieves or other technical/industrial wovens.

### CLAIM OF PRIORITY

This application is based upon German Patent Application No. DE 10 2007 009 118.6, entitled “Elektrisch leitfaähige Fäden, daraus hergesteilte Flächengebilde und deren Verwendung”, filed Feb. 24, 2007. The priority of German Patent Application No. DE 10 2007 009 118.6 is hereby claimed and its disclosure incorporated herein by reference.

### TECHNICAL FIELD

The present invention concerns strands having very high electrical conductivities and excellent mechanical properties. These strands, which are monofilaments in particular, are useful in screens or conveyor belts for example.

### BACKGROUND

It is known that polyester fibers for industrial applications are in most cases subjected to high mechanical and or thermal stressors in use. In addition, there are in many cases stressors due to chemical and other ambient influences, to which the material has to offer adequate resistance. As well as adequate resistance to all these stressors, the material has to possess good dimensional stability and constancy for its stress-strain properties over very long use periods. Nor may an electrostatic charge build up on the material during processing and in use.

One example of industrial applications comprising a combination of high mechanical, thermal, chemical and electrical stresses is the use of monofilaments in filters, screens or as conveyor belts. This use requires monofilaments having excellent mechanical properties, such as high initial modulus, breaking strength, knot strength, loop strength and also high abrasion resistance coupled with high hydrolysis resistance in order that they may withstand high stresses encountered in their use and in order that the screens or conveyor belts may have an adequate use life.

Industrial manufacturers, such as paper makers or processors, utilize filters or conveyor belts in operations taking place at elevated temperatures and in hot moist environments. Polyester-based manufactured fibers have a proven record of good performance in such environments, but when used in hot moist environments polyesters are vulnerable to mechanical abrasion as well as hydrolytic degradation.

Abrasion can have a wide variety of causes in industrial uses. For instance, the sheet-forming wire screen in papermaking machines is in the process of dewatering the paper slurry pulled over suction boxes, and this results in enhanced wear of the wire screen. At the dry end of the papermaking machine, wire screen wear occurs as a consequence of speed differences between the paper web and the wire screen surface and between the wire screen surface and the surface of the drying drums. Fabric wear due to abrasion also occurs in other industrial fabrics, for instance in transportation belts due to dragging across stationary surfaces, in filter fabrics due to the mechanical cleaning and in screen printing fabrics due to the movement of a squeegee across the screen surface.

The forming wire screens of state of the art papermaking machines utilize multi-ply woven fabrics. To maximize the speed of dewatering the paper, suction boxes are utilized on the wire screen underside to speed paper web dewatering by means of underpressure. The contact surfaces of the edges of these suction boxes with the forming fabric consist in general of ceramic to prevent excessive wear of the suction boxes.

On the other hand, the high manufacturing speeds, the rubbing due to the fillers added to the monofils and the sucking effect of the papermaking machine lead to high wear on the underside of the multi-ply forming fabric.

Monofilaments made of nylon, for example nylon-6 or nylon-6,6, are still being used to improve the abrasion resistance of the wire screen underside. This is where it is predominantly monofilaments made of polyethylene terephthalate (hereinafter PET) which are used because of their higher dimensional stability, and it is of them that the forming wire screen fabric consists essentially. One tried and tested construction for the wire screen underside is that of an alternating weft in which a backing weft of a nylon monofil alternates with a backing weft of PET monofil. This results in a compromise of abrasion resistance and dimensional stability.

The higher water imbibition of nylons compared with PET leads to lengthening of the weft threads in operation of the wire screen. As a result, the wire screens are prone to the undesirable effect known as edge curling in that they curl up at the edges and no longer lie flat within the papermaking machine.

There have been numerous attempts to replace nylon monofilaments with monofilaments made of other abrasion-resistant polymers that have a low water imbibition as well as being deformation resistant.

An example is monofilaments made of PET blends admixed with 10-40% of thermoplastic polyurethane (TPU) (cf. for example EP-A-387,395). Similarly, mixtures of thermoplastic polyester, for example polyethylene terephthalate isophthalate, and thermoplastic polyurethane having melting points of 200 to 230° C. have been used (cf. for example EP-A-674,029).

The prior art further comprises monofilaments having a core-sheath structure in each of which the sheath consists of a mixture of thermoplastic polyester having a melting point of 200 to 300° C., for example PET, and of thermoplastic elastomeric copolyetherester having selected polyetherdiol building block groups as soft segments, that likewise exhibit improved abrasion resistance (cf. for example EP-A-735,165).

Further polyester compositions comprising crystalline thermoplastic polyester resins, polyester elastomers and sorbitan esters are known from DE 691 23 510 T2. These are notable for good moldability, in particular for good releaseability.

DE 690 07 517 T2 discloses polyester compositions comprising an aromatic polycarbonate, a polyester derived from alkanediol and benzene-dicarboxylic acids, and a polyesterurethane elastomer or a polyether imide ester elastomer. These combine improved flow properties with good mechanical properties.

While these prior art strands do provide adequate abrasion resistance, electrical conductivity still leaves something to be desired in many cases. True, it has long been known that carbon black can be incorporated in strands to improve electrical conductivity. However, prior art solutions typically only provide electrical conductivities of up to 10⁻⁶ siemens/cm. When prior art carbon blacks are used to enhance electrical conductivity, it is found that when the strands produced are drawn the conductive paths formed by the carbon black are interrupted, and that a distinct reduction in electrical conductivity occurs as a result.

WO-A-98/14,647 describes an attempt to remedy this disadvantage by producing a sheath-core filament comprising a sheath polymer having a lower melting point than the core polymer. After drawing, the sheath is incipiently melted, so that the strand shrinks and interrupted bridges of electrically conductive material can re-form. This does indeed push electrical conductivity back up; however, the thermal treatment leads to a decrease in the degree of orientation of the molecular chains and hence to a reduction in the strength of the filament.

EP-A-1,559,815 describes coating a ready-produced strand with a mixture of carbon nanotubes and a polymer. Since the coated strand is not further stretched, the carbon bridges in the amorphous coating are not ruptured, which results in very good electrical conductivities.

### SUMMARY OF INVENTION

The present invention has for its object to provide strands having outstanding electrical conductivity as well as good mechanical properties and excellent abrasion resistance.

It has now been found that, surprisingly, strands comprising a selected combination of matter have this property portfolio.

The present invention accordingly provides melt-spun strands having a modulus of elasticity of less than 6 GPa, preferably in the range from 0.1 to 5.5 GPa, and an elastic extension of greater than 1.5%, preferably of greater than 1.5% to 4%, comprising: a) a thermoplastic polymer, preferably a polyamide, polybutylene terephthalate, polypropylene terephthalate and/or a polyether ester, b) a thermoplastic elastomeric block copolymer and c) carbon black and/or graphite particles in the form of aggregates aligned along the longitudinal axis of the strand which form electrically conductive paths along the longitudinal axis of the strand, where components a) and b) may be identical when component a) is a polyether ester.

### DETAILED DESCRIPTION

The invention is described in detail below with reference to several embodiments and numerous examples. Such discussion is for purposes of illustration only. Modifications to particular examples within the spirit and scope of the present invention, set forth in the appended claims, will be readily apparent to one of skill in the art. Terminology used herein is given its ordinary meaning consistent with the exemplary definitions set forth immediately below.

The term “strands” herein is to be understood as referring very generally to fibers of finite length (staple fibers), fibers of infinite length (filaments) and also multifilaments composed thereof, or yarns secondarily spun from staple fibers. The melt-spun strands are preferably used in the form of monofilaments.

“Modulus of elasticity” herein refers to the secant modulus of the stress-strain curve between 0% and 1% strain.

“Elastic extension” herein refers to the linear course of the stress-strain curve from its origin to its departure from linearity. An elastic extension of 1.5% thus corresponds to a linear course of the stress-strain curve from 0% to 1.5% strain; an elastic extension of 4% consequently indicates a linear course of the stress-strain curve from 0% to 4%.

In accordance with the present invention, the polymers used for component a) are fiber-forming thermoplastic polymers which, after spinning, drawing and, if appropriate relaxing, give strands having the above-described moduli of elasticity and elastic extensions.

The thermoplastic polymers of component a) can be of any desired origin provided they are melt spinnable and permit the production of strands having the above-defined elastic extensions and moduli of elasticity.

Examples of suitable thermoplastic polymers are polyolefins, such as polyethylene, polypropylene or copolymers containing ethylene and/or propylene units in conjunction with other copolymerized alpha-olefin units, such as alpha-butylene, alpha-pentylene, alpha-hexylene or alpha-octylene; polyesters, such as polycarbonate or aliphatic/aromatic polyesters; polyamides, such as aliphatic or alphatic/aromatic polyamides; or polyether esters, i.e., polymers having at least ether and ester groups and generally aromatic bivalent radicals, such as phenylene, in the recurring chain, for example TPE-E; or polyacrylonitrile or polyacrylonitrile copolymers with other ethylenically unsaturated comonomers, such as acrylic acid or methacrylic acid.

Component a) preferably utilizes polyamides, polybutylene terephthalate, polypropylene terephthalate or polyether esters.

Examples of polyamides are aliphatic or aliphatic/aromatic amides, e.g., polycaprolactam, poly(hexamethylene-1,6-diamine adipamide), poly(hexamethylene-1,6-diamine-sebacamide), poly(hexamethylene-1,6-diamine-terephthalamide) or poly(hexamethylene-1,6-diamine isophthalamide).

The polyamides used according to the present invention have DIN 53727 viscosity numbers which are typically in the range from 120 to 350 cm³/g and preferably in the range from 150 to 320 cm³/g (measured at 25° C. in sulfuric acid).

The thermoplastic polyesters preferably used as component a) in the strands of the present invention are likewise known per se. However, the polyesters chosen shall permit the production of strands having the above-indicated moduli of elasticity and values of elastic extension.

Possibilities include polycarbonate or, in particular, aliphatic/aromatic polyesters of the polybutylene terephthalate and/or polypropylene terephalate types, which may if appropriate be mixed with other polyesters, as with polyethylene terephthalate, in amounts of up to 40% by weight and preferably up to 15% by weight, based on the total amount of component a).

Thermoplastic and elastomeric polyether esters are a further preferred group of polymers which is used as component a). Thermoplastic and elastomeric polyether esters are known per se. When these polyether esters are used, they may be identical to polymers of component b); that is, there may be cases where strands only contain component a) and no additional component b).

Examples of suitable thermoplastic and elastomeric polyether esters are copolymers which, as well as polyethylene terephthalate, polycyclohexane dimethyl terephthalate, polyethylene naphthalate or, in particular, polybutylene terephthalate units, contain further units which are derived from aromatic and/or aliphatic and/or cycloaliphatic dicarboxylic acids, in particular from adipic acid, sebacic acid, terephthalic acid, cyclohexanedicarboxylic acid or isophthalic acid, and from polyalkylene glycols, in particular polyethylene glycols.

Building blocks of thermoplastic and elastomeric polyether esters are preferably diols, polyetherdiols and dicarboxylic acids, or correspondingly constructed polyester-forming derivatives. The main acid constituent of the copolyesters comprises terephthalic acid or cyclohexanedicarboxylic acid, but other aromatic and/or aliphatic or cycloaliphatic dicarboxylic acids may also be suitable, preferably para- or trans-disposed aromatic compounds, for example 2,6-naphthalenedicarboxylic acid or 4,4′-biphenyldicarboxylic acid, and also isophthalic acid. Aliphatic dicarboxylic acids, such as adipic acid or sebacic acid for example, are preferably used in combination with aromatic dicarboxylic acids.

Useful dihydric alcohols typically include aliphatic and/or cycloaliphatic diols, for example ethylene glycol, propanediol, 1,4-butanediol, 1,4-cyclohexane-dimethanol or mixtures thereof. Preference is given to aliphatic diols having two to four carbon atoms, particularly ethylene glycol and butanediol. Preference is further given to cycloaliphatic diols, such as 1,4-cyclohexanedimethanol. These dihydric alcohols combine with the dicarboxylic acid units to form the hard segments of the thermoplastic and elastomeric polyether ester. The soft segments of this copolyester are formed by structural repeat units derived from polyetherdiols and dicarboxylic acids. The polyetherdiols typically comprise polyalkylene glycols, such as polyethylene glycol, polypropylene glycol or polybutylene glycol.

Preference for use as component a) is given to copolyether esters comprising structural repeat units derived from an aromatic dicarboxylic acid and an aliphatic diol and also from a polyalkylene glycol.

Preferred thermoplastic and elastomeric polyether esters have structural repeat units derived from terephthalic acid, ethylene glycol and polyethylene glycol, or from terephthalic acid, butylene glycol and polyethylene glycol, or from terephthalic acid, butylene glycol and polybutylene glycol, or from naphthalenedicarboxylic acid, ethylene glycol and polyethylene glycol, or from naphthalenedicarboxylic acid, butylene glycol and polyethylene glycol, or from naphthalenedicarboxylic acid, butylene glycol and polybutylene glycol, or from terephthalic acid, isophthalic acid, ethylene glycol and polyethylene glycol, or from terephthalic acid, isophthalic acid, butylene glycol and polyethylene glycol, or from terephthalic acid, isophthalic acid, butylene glycol and polybutylene glycol.

The polyesters used according to the present invention for component a) typically have solution viscosities (IV values) of at least 0.60 dl/g, preferably of 0.60 to 1.05 dl/g, and more preferably of 0.62-0.93 dl/g (measured at 25° C. in dichloroacetic acid (DCE)).

Preference is given to strands of polyesters or polyether esters having a free carboxyl group content of not more than 3 meq/kg.

These preferably comprise an agent for capping free carboxyl groups, for example a carbodiimide and/or an epoxy compound.

Polyester strands thus endowed are stable to hydrolytic degradation and are particularly suitable for use in hot moist environments, in particular in papermaking machines or as filters.

The thermoplastic and elastomeric block copolymers of component b) may comprise a wide variety of types. Such block copolymers are known to one skilled in the art.

Examples of components b) are thermoplastic and elastomeric polyurethanes (TPE-Us), thermoplastic and elastomeric polyesters (TPE-Es), thermoplastic and elastomeric polyamides (TPE-As), thermoplastic and elastomeric polyolefins (TPE-Os) and thermoplastic and elastomeric styrene block copolymers (TPE-Ss).

The thermoplastic and elastomeric block copolymers b) may be constructed from a wide variety of different monomer combinations. The blocks in question generally comprise so-called hard and soft segments. Soft segments are typically derived from polyalkylene glycol ethers in the case of the TPE-Us, the TPE-Es and the TPE-As. Hard segments are typically derived from short-chain diols or diamines in the case of the TPE-Us, the TPE-Es and the TPE-As. As well as from diols or diamines, the hard and soft segments are constructed from aliphatic, cycloaliphatic and/or aromatic dicarboxylic acids or diisocyanates.

Examples of thermoplastic polyolefins are block copolymers comprising blocks of ethylene-propylene-butadiene and of polypropylene (EPDM/PP) or of nitrile-butadiene and of polypropylene (NBRIPP).

Thermoplastic and elastomeric styrene block copolymers are particularly preferred components b). Examples are block copolymers comprising blocks of styrene-ethylene and of propylene-styrene (SEPS) or of styrene-ethylene and of butadiene-styrene (SEBS) or of styrene and of butadiene (SBS).

Thermoplastic and elastomeric block copolymers herein are block copolymers which have a similar room temperature behavior to conventional elastomers, but are plastically deformable on heating and thus exhibit a thermoplastic behavior. These thermoplastic and elastomeric block copolymers have subregions with physical points of crosslinking (for example, secondary valency forces or crystallites) which become unlinked on heating without the polymer molecules decomposing.

Component c) comprises selected particles of carbon black and/or of graphite. The carbon blacks or graphites in question have primary particles which are arranged in the form of aggregates which preferably have the form of a clew, in particular in the form of elongated strands. The carbon blacks used according to the present invention consist of nanoscale primary particles. These are generally spherical and typically have diameters in the range from 10 to 300 nm. Owing to the pronounced anisotropy of the aggregates of carbon black particles or graphite platelets that are used according to the present invention, longitudinally oriented aggregates form in the course of the spinning of the strand, and form electrically conductive paths along the longitudinal axis of the strand. In the undrawn strand, these aggregates are partly present in dewed form and are extended in the longitudinal direction of the strand, but not ruptured, by the drawing operation. The electrically conductive paths in the strand thus remain intact.

Particular preference for use as components c) is given to carbon blacks which are present in the strand in the form of elongate aggregates constructed of a plurality of primary particles in contact with one another, and which endow the drawn strand with an electrical conductivity of at least 0.5*10⁻⁶ siemens/cm and preferably at least 1.0*10⁻⁵ siemens/cm, measured in the longitudinal direction of the strand.

The amounts of components a), b) and c) in the strands of the present invention can be chosen within wide limits. The strands typically contain 20% to 70% by weight of component a), 15% to 40% by weight of component b) and 5% to 50% by weight of component c), all based on the total mass of the strand.

The combination of components a), b) and c) which is used according to the present invention endows the strands not only with excellent abrasion resistance but also with good textile-technological properties, in particular good dynamic properties and an excellent dimensional stability, and also with outstanding electrical conductivity.

The components a), b) and c) used for producing the strands of the present invention are known per se, partly commercially available or obtainable by processes known per se.

The strands of the present invention, as well as components a), b) and c), may further comprise further, adjunct materials d).

Examples thereof include, in addition to the aforementioned hydrolysis stabilizer, processing aids, antioxidants, plasticizers, lubricants, pigments, delusterants, viscosity modifiers or crystallization accelerants.

Examples of processing aids are siloxanes, waxes or comparatively long-chain carboxylic acids or their salts, aliphatic, aromatic esters or ethers.

Examples of antioxidants are phosphorus compounds, such as phosphoric esters or sterically hindered phenols.

Examples of pigments or delusterants are organic dye pigments or titanium dioxide.

Examples of viscosity modifiers are polybasic carboxylic acids and their esters or polyhydric alcohols.

The strands of the present invention can be present in any desired form, for example as multifilaments, as staple fibers, as secondarily spun yarns, including in the form of threads, or particularly as monofilaments.

In a particularly preferred embodiment, the strands of the present invention are in the form of multicomponent strands. Examples thereof are side-by-side strands or, in particular, sheath-core strands. The sheath in the sheath-core strands preferably consists of a composition comprising components a), b), c) and if appropriate d), while the core consists of a fiber-forming polymer which determines the mechanical properties, chiefly the strength and breaking extension, of the overall strand.

A particularly preferred combination is a sheath-core strand whose core consists of polyamide, selected polyester or elastomeric polyether ester, preferably of polybutylene terephthalate, polypropylene terephthalate, nylon 6 or mixtures thereof, and whose sheath contains the components b), c) and if appropriate d) in combination with a thermoplastic polymer, preferably a thermoplastic polyester or polyamide, in particular polyethylene terephthalate homopolymers, polyethylene terephthalate copolymer or nylon 6.

In preferred sheath-core strands, the weight ratio of core and sheath is in the range from 95:5 to 20:80, preferably in the range from 75:25 to 45:55 and particularly in the range from 70:30 to 50:50.

The linear density of the strands according to the present invention can vary within wide limits. Examples thereof are 1 to 45 000 dtex and especially 100 to 4000 dtex.

The cross-sectional shape of the strands according to the present invention is freely choosable, examples being round, oval or n-gonal, where n is not less than 3.

The strands of the present invention are obtainable by processes known per se.

A typical production process comprises the measures of: i) extruding a mixture comprising components a), b) and c) through a spinneret die, ii) withdrawing the resulting filament, iii) drawing and iv) if appropriate, relaxing the resulting filament.

Multicomponent strands are produced in a similar manner. Except that in this case the spinning dopes which form the different compositions are melted in different extruders and pressed through a multicomponent spinneret die.

The composition comprising a thermoplastic polymer, components b), c) and if appropriate d) or comprising components a), b), c) and, if appropriate, d) is preferably used in the form of a master batch.

The strands of the present invention are subjected to drawing, in one or more stages, in the course of their production.

It is particularly preferable to produce the strands using as component a) and/or as component of the core strand a polyester produced by solid state condensation.

After the polymer melt has been forced through a spinneret die, the hot strand of polymer is quenched, for example in a quench-bath, preferably in a water bath, and subsequently wound up or withdrawn. The withdrawal speed is greater than the ejection speed of the polymer melt.

The strand thus produced is subsequently subjected to an afterdrawing operation in one or more stages, if appropriate set and wound up, as known from the prior art for the melt-spinnable polymers mentioned.

The strands of the present invention are preferably used for producing textile fabrics, particularly woven fabrics, spiral fabrics, nonwoven scrims or drawn-loop knits. These textile fabrics are preferably used in screens.

Textile fabrics comprising the strands of the present invention likewise form part of the subject matter of this invention.

The strands of the present invention can be used in all industrial fields. They are preferably employed for applications where increased wear due to mechanical stress and also a buildup of static electricity is likely. Examples thereof are the use in screen wovens and filter cloths for gas and liquid filters, in drying belts, for example in the manufacture of food products, in packaging containers or in hoses for conveying small particles. These uses likewise form part of the subject matter of the present invention.

A further use of the strands of the present invention in the form of monofilaments concerns their use as conveyor belts or as components of conveyor belts.

The strands of the present invention may also be used in screens which are wire screens and intended for use papermaking machines.

These uses likewise form part of the subject matter of the present invention.

The examples which follow elucidate the invention without limiting it.

### EXAMPLES

### Working Description for Producing Sheath-Core Monofilaments of Examples 1 to 3

The components for the core were melted in an extruder. The components for the sheath in the form of a masterbatch (Deltacom PET 1917 EC3, from Delta Kunststoffe Produktions- und Handelsgesellschaft mbH, Weeze, Germany) of polyethylene terephthalate (PET), thermoplastic elastomer, conductivity carbon black and additives were mixed and melted in another extruder. The melted spinning dopes from the two extruders were spun in a bicomponent spinneret die having 20 holes 1.0 mm in diameter at a feed rate of 488 g/min and a withdrawal speed of 31 m/min to form monofilaments having a sheath-core structure, which were drawn, and heat set in a hot air duct at 255° C. with shrinkage being allowed.

The masterbatch consisted of 50% by weight of the PET type described above and also 27% by weight of a thermoplastic, elastomeric styrene block copolymer, 20% by weight of a conductivity carbon black and 3% by weight of processing stabilizer, lubricant, sterically hindered amine and silane.

The diameter of the monofilaments produced, the composition of the core, the sheath and core fractions and also the textile-technological data of the monofilaments obtained are shown in the table which follows:

TABLE 1
Monofilament Characteristics

| | Example 1 | Example 2 | Example 3 |
|---|---|---|---|
| Core material | Nylon 6 | Polybutylene | Polyether ester¹⁾ |
| | | terephthalate | |
| Core:sheath ratio | 90:10 | 90:10 | 75:25 |
| (% by weight) | | | |
| Diameter (μm) | 453 | 401 | 254 |
| Linear density (dtex) | 1856 | 1616 | 638 |
| Tensile strength (cN/tex) | 38.4 | 10.4 | 30.2 |
| Modulus of elasticity | 4.0 | 2.7 | 1.1 |
| (GPa) | | | |
| Elastic extension (%) | 2 | 2 | 19 |
| Breaking extension (%) | 41.7 | 16.7 | 69.5 |
| el. resistance²⁾ (S/cm) | 1.0 * 10⁻⁵ | 1.0 * 10⁻⁵ | 1.0 * 10⁻⁵ |
| el. resistance³⁾ (S/cm) | 4.0 * 10⁻⁶ | 7.0 * 10⁻⁶ | — |
| el. resistance⁴⁾ (S/cm) | — | — | 3.0 * 10⁻⁷ |
| el. resistance⁵⁾ (S/cm) | — | — | 2.0 * 10⁻⁹ |
| el. resistance⁶⁾ (S/cm) | — | — | >10 * 10⁻¹² |

¹⁾Riteflex ® RKX192 elastomeric polyether ester copolymer
²⁾before first extension
³⁾after 100 extensions to 1.5% each
⁴⁾after 100 extensions to 2% each
⁵⁾after 100 extensions to 3% each
⁶⁾after 100 extensions to 4% each

Fiber properties were determined as follows:
tensile strength in accordance with DIN EN/ISO 2062
breaking extension in accordance with DIN EN/ISO 2062

### Electrical Conductivity was Determined as Follows:

The monofilament was clamped between two jaws under slight pre-tension, and silverized at two positions. Electrical clamps connected to a resistance meter (Metra Hit 15 S; measuring range up to 30 MΩ) were attached at the silverized locations. The clamp spacing chosen was between 10 mm and 300 mm. A clamp spacing of 100 mm has been used as standard. The resistance per cm, i.e., Ω/cm, was measured. The conductivity value is the reciprocal resistance for 1 centimeter of monofil length.

Example: R=620 kΩ/10 cm corresponds to R=62 kΩ/cm corresponds to L=1.6*10⁻⁵ S/cm.

While the invention has been described in connection with several examples, modifications to those examples within the spirit and scope of the invention will be readily apparent to those of skill in the art. In view of the foregoing discussion, relevant knowledge in the art and references discussed above in connection with the Background and Detailed Description, the disclosures of which are all incorporated herein by reference, further description is deemed unnecessary.

What is claimed is:

1. A melt-spun strand having a modulus of elasticity of less than 6 GPa and an elastic extension of greater than 1.5%, comprising:
a) a thermoplastic polymer,
b) a thermoplastic elastomeric block copolymer, and
c) carbon black and/or graphite particles in the form of aggregates aligned along the longitudinal axis of the strand which form electrically conductive paths along the longitudinal axis of the strand, where components a) and b) may be identical when component a) is a polyether ester.

2. The strand according to claim 1, wherein component a) is a polyamide, polybutylene terephthalate, polypropylene terephthalate and/or a polyether ester.

3. The strand according to claim 1, having a modulus of elasticity in the range from 0.1 to 5.5 GPa and an elastic extension of greater than 1.5% to 4%.

4. The strand according to claim 1, wherein component b) is a thermoplastic polyurethane elastomer, a thermoplastic polyester elastomer, thermoplastic styrene block copolymer or a combination of two or more thereof.

5. The strand according to claim 1, wherein component b) is a thermoplastic, elastomeric styrene block copolymer, in particular a styrene-butadiene-styrene block copolymer or a styrene-ethylene-butadiene-styrene block copolymer..

6. The strand according to claim 1, wherein component c) is a carbon black which is present in the strand in the form of elongate aggregates constructed of a plurality of primary particles in contact with one another, and which effects an electrical conductivity for the strand of at least 0.5*10⁻⁶ siemens/cm, preferably at least 1.0*10⁻⁵ siemens/cm, measured in the longitudinal direction of the strand.

7. The strand according to claim 1, wherein the strand is a sheath-core strand whose core is formed of thermoplastic polymer and whose sheath comprises a thermoplastic polymer, preferably polyethylene terephthalate, and components b) and c) or components a), b) and c).

8. The strand according to claim 7, wherein the core is formed of a polymer.

9. The strand according to claim 7, wherein the weight ratio of core and sheath is in the range from 95:5 to 20:80, preferably in the range from 75:25 to 45:55 and especially in the range from 70:30 to 50:50.

10. The strand according to claim 1, being a monofilament.

11. A textile fabric, in particular a woven fabric, comprising strands according to claim 1.

12. The textile fabric according to claim 11, which comprises further strands of polyester, in particular of polyethylene terephthalate.

13. The use of a strand according to claim 1, in textile fabrics for technical/industrial applications, in particular in screen wovens and filter cloths for gas and liquid filters, in drying belts, preferably in the manufacture of food products, in packaging containers, in hoses for conveying small particles or as conveyor belts or as components of conveyor belts.
